(19) United States
(12) Patent Application Publication
(10) Pub. No.: US 2004/0033746 A1
(43) Pub. Date: Feb. 19, 2004

(54) Nonwoven fabric for eletrical insulation, prepreg and laminate

(76) Inventors: Shigeru Kurumatani, Hikone-shi (JP); Manabu Ochida, Hikone-shi (JP); Hirokazu Hiraoka, Kanzaki-gun (JP)

Correspondence Address: PEARNE & GORDON LLP, 1801 EAST 9TH STREET, SUITE 1200, CLEVELAND, OH, 44114-3108, US

(21) Appl. No.: 10/380,637

(22) PCT Filed: Sep. 17, 2001
(86) PCT No.: PCT/JP01/08064

(30) Foreign Application Priority Data
Sep. 20, 2000 (JP) 2000-285370
Jan. 30, 2001 (JP) 2001-21351

(51) Int. Cl. B32B 27/02; B32B 5/02; B32B 27/12; D04H 1/00; B32B 5/16

(52) U.S. Cl. 442/149; 442/415; 442/414; 442/417; 442/169

(57) ABSTRACT

An electrically insulating non-woven fabric having a main component of poly-p-phenileneterephthalamide fibers bonded with each other by a binder of thermosetting resin and a second binder of one selected from fiber chops, fiber pulps and fibrids of thermoplastic resin having a softening point of 220° C. or higher, the poly-p-phenileneterephthalamide fibers being pulps or both of chops and pulps with a blend mass ratio of the chops to the pulps being 0/100 through 95/5 and preferably 50/50 through 90/10, a fiber length of the poly-p-phenileneterephathalamide fiber chops being preferably 3 to 6 mm, a content of the thermosetting resin binder in the non-woven fabric being 5 to 30 mass % and a content of the second binder being is 5 to 15 mass %.

### TECHNICAL FIELD

This invention relates to an electrically insulating non-woven fabric including a main component of para-amid fibers, a prepreg having a base material of this electrically insulating non-woven fabric and a laminate (including a concept of a printed circuit board and a multi-layer printed circuit board). The printed circuit board and the multi-layer printed circuit board may be suitably used for surface-mounting leadless chip parts such as resistors, IC and so on.

### TECHNICAL BACKGROUND

In the case where electronic parts such as resistors, IC and so on are mounted on a printed circuit board which should be assembled in an electronic appliances, these parts in the form of chip have been generally mounted on the printed circuit board by a surface mounting system. The surface mounting system is a preferable system in view of requirements of compactness and lightness of the electronic appliances and high density thereof. Accompanying the densification of the printed circuit board, a connection of the wirings between which an insulation layer is provided is made through an IVH (Interstitial Via Hole) formed in the insulation mainly by a hole making system such as a radiation of laser light. Thus, it will be noted that the printed circuit board is required to have a property of being more easily hole-made by the radiation of laser light.

Also, in the case where the leadless chip parts are surface-mounted on the printed circuit board, the latter is required to have a coefficient of thermal expansion matched with that (2 to 7 ppm/° C.) of the leadless chip parts as much as possible.

In addition thereto, the printed circuit board desirably has a size variation (thermal shrinkage) as small as possible in order to improve a reliability of connection of the wirings between which the insulation is provided. This is particularly important for the multi-layer printed circuit board.

In this view, a non-woven fabric including a main component of para-aramid fibers having a negative coefficient of thermal expansion has been developed as a base material of which the insulation of the printed circuit board is formed. Such an electrically insulating non-woven fabric has been made as follows, for example.;

(1) Non-woven fabric produced by paper-making chops of para-aramid fibers (poly-p-phenilene-3,4′-dipheniletherterephthalamide fibers) and chops of thermoplastic resin fibers having a softening temperature of 220° C. or higher while mixing them with each other, bonding the fibers of them with each other by a thermosetting resin binder and thermally adhering the chops of thermoplastic resin fibers having the softening temperature of 220° C. or higher with the chops of para-aramid fibers (see JP10-138381A).

(2) Non-woven fabric produced by paper-making chops of para-aramid fibers (poly-p-phenileneterephthalamide fibers) and fibrids of meta-aramid while mixing them with each other and intertwining the fibrids of meta-aramid with the chops of para-aramid fibers (see JP10-160500A).

These non-woven fabrics including the para-aramid fibers have been used as a base material of an insulation layer when a multi-layer printed circuit board is produced by a building-up process. A PET film is laminated on a surface of a prepreg formed by impregnating the base material with a thermosetting resin and heating and drying it, a laser light is radiated on the prepreg at its predetermined places to make holes and paste-like electrically conducting material is filled in the holes. The electrically conductive material is used for electrically conductive printed wirings between which the insulation layer is provided. After the PET film is removed from the prepreg layer having the paste-like electrically conductive material filled therein, copper foils are placed on both surfaces of the prepreg, the prepreg and the copper foils are integrally formed under heat and under pressure and then the copper foils are worked into printed wirings whereby the printed circuit board having a first layer of printed wirings are formed.

On the thus produced printed circuit board is placed a copper foil while a separate prepreg having the paste-like electrically conducting material filled therein is provided between the printed circuit board and the copper foil and they are integrally formed under heat and under pressure and then the copper foil is worked into the printed wirings. In this manner, the printed wirings are built up to form the multi-layer printed circuit board (see JP 5-175650A and JP7-176846A).

According to these prior arts, there can be produced the multi-layer printed circuit board having the upper and lower printed wirings between which the insulation layer is provided and connected via the complete IVH. The IVH may be formed in the upper insulation layer just above the conductor formed by curing the paste-like electrically conductive material.

Poly-p-phenilene-3,4′-dipheniletherterephthalamide fibers, one of the para-aramid fibers should be drawn for improving the strength of the fibers when they are spun, but the thus drawn fibers tend to be shrunk when heated. The printed circuit board including as a base material of the insulation layer the non-woven fabrics having the main component of these fibers has a high size shrinkage (thermal shrinkage) when it reflows. Thus, the connection of the parts surface-mounted on the printed circuit board and the connection of the printed wirings between which the insulation layer is provided disadvantageously have a poor reliability.

Poly-p-phenileneterephthalamide fibers, another of the para-aramid fibers are liquid-crystal-spun to have a much higher crystallization and therefore have a strong bond of molecules. The prepregs or the printed circuit boards including the base material of the non-woven fabrics having the main component of these fibers have a problem in hole-making by radiation of laser light. Poly-p-phenileneterephthalamide fibers have a high thermal decomposition temperature and therefore have a poorer thermal decomposition and a poorer scattering of the base material by the laser light radiation than the resin with which the non-woven fabric is impregnated. Thus, the surfaces of the walls of the holes tend to have roughness and therefore the paste-like electrically conductive material with which the holes are filled tends to get blurred and also has a poor soldering. This possibly causes the poor connection of the printed circuits through the interstitial-via-hole (IVH).

Since these poly-p-phenileneterephthalamide fibers are liquid-crystal-spun, but not drawn and spun, they have a lower thermal shrinkage and a good size stability. Therefore, as the non-woven fabric having these fibers paper-made and bonded by a thermal setting resin binder is used for a prepreg, the better size stability and the less warp of the laminate will be expected. However, it is found that it is not true because the prepregs tend to meander due to the shrinkage by the heat applied thereto and therefore the laminate having the prepregs used also tends to be wound when thermally treated.

Accordingly, it is an object of the invention to provide a prepreg or a laminate suitable for a printed circuit board having an insulation layer base material of non-woven fabric having a main component of para-aramid fibers such as poly-p-phenileneterephthalamide fibers, for example wherein the printed circuit board has a less warp due to heat.

It is another object of the invention to provide a prepreg or a laminate suitable for a printed circuit board wherein a paste-like electrically conductive material is prevented from blurring when a hole formed in the prepreg by radiating laser light is filled with the paste and wherein a connection of wiring layers of the printed circuit board has an improved reliability by getting a smaller roughness of the wall of the IVH formed by radiating laser light to an insulation layer of the printed circuit board.

It is another object of the invention to provide a prepreg adapted to prevent a thermal shrinkage.

It is further object of the invention to provide an electrically insulating non-woven fabric that can be suitably used for a printed circuit board adapted to accomplish the aforementioned objects.

### DISCLOSURE OF THE INVENTION

An electrically insulating non-woven fabric of the invention is of a fabric having a main component of para-aramid fibers bonded with each other by a binder and in order to accomplish the object of the invention, the fibers are bonded with each other by a thermosetting resin binder and a second binder of one selected from fiber chops, fiber pulps and fibrids, which are formed of thermoplastic resin having a softening point of 220° C. or higher, the para-aramid fibers characterized by including (a) poly-p-phenileneterephthalamide fiber pulps or (b) both of poly-p-phenileneterephthalamide fiber chops and poly-p-phenileneterephthalamide fiber pulps with a blend mass ratio of the fiber chops of poly-p-phenileneterephthalamide to the fiber pulps of poly-p-phenileneterephthalamide being 0/100 through 95/5.

As the para-aramid fibers mainly includes poly-p-phenileneterephthalamide especially in the form of fiber pulps as aforementioned, the laminate formed of such fabric as a base material can be prevented from the size shrinkage due to heat.

A characteristic of a hole-making operation by a laser radiation of prepregs having such fibers as a base material can be improved by the presence of poly-p-phenileneterephthalamide fiber pulps.

The fiber pulps of poly-p-phenileneterephthalamide may be formed by beating fiber chops into fine branch separation form. The degree of branch separation form may be expressed by the index of the beating degree called freeness (csf). It will be understood that the beating progresses as the freeness gets smaller. The freeness is preferably 550 csf or less and most preferably 1 through 200 csf. The beating degree used in the present invention is of a value of ml regulated by JIS-P-8121.

Since the fiber chops at their gaps are filled with the finely branch-separated fiber pulps, the poly-p-phenileneterephthalamide fibers having the high thermal decomposition temperature are uniformly distributed in the whole thickness direction of the fabric. As a result, when the hole-making operation is carried out by radiating the laser light onto the fabric, there is no unevenness between the parts where a sublimation is easy to arise on the inner face of the hole wall and the parts where the sublimation is hard to arise thereon and therefore the result state of the hole wall gets better. This improves the reliability of the connection between the wiring layers which is accomplished through the electrically conductive paste filled in the hole because the roughness of the hole wall is reduced. Similarly, the reliability of the connection between the wiring layers which is accomplished by plating the hole wall.

Since the hole-making operation by the radiation of laser light can be more easily accomplished as there is used only the fiber pulps of fine fibers or the papering mixture of the fiber chops and the fiber pulps having the high blend ratio of fiber pulps relative to the fiber chops, the ratio of the thin fiber occupied in the non-woven fabric gets higher and therefore the hole-making operation by the radiation of laser light can be easily accomplished. However, as the papering mixture of the fiber chops and the fiber pulps has the blend mass ratio of the fiber chop relative to the fiber pulp beyond 95, the fiber pulps with which the gap of the fiber chop is filled get shorter, and the roughness of the hole wall formed by the radiation of laser light gets larger. In consideration of the heat resistance of the insulating layer formed by the non-woven fabric as the base material and the smaller roughness of the hole wall, the blend mass ratio of the fiber chop and the fiber pulp is preferably 50/50-90/10.

In order to prevent the thermal shrinkage of the prepregs and the warp of the laminate due to heat, the modulus of elasticity of the non-woven fabric is required to increase. This contributes to the higher modulus of elasticity of the prepregs and the laminate, which leads to prevention of the thermal shrinkage of the prepregs and the warp of the laminate due to heat.

In the invention, the thermosetting resin binder is attached to the cross points of the fibers to thereby bind the fibers with each other while the second binder is thermally molten and adhered to the para-aramid fiber chops and/or intertwined therewith to bond them with each other. The combination of the two binders contributes to an improvement of the modulus of elasticity of the non-woven fabric and in other words contributes to the prevention of the reduction due to heat of the modulus of elasticity of the prepregs and the laminate.

The second binder comprises at least one selected from the forms of fiber chops, fiber pulps and fibrids of thermoplastic resin having a softening temperature of 220° C. or higher. The fiber chops are formed by cutting straight fibers into ones having predetermined size enabling the paper-making, the fiber pulps are formed by beating the fiber chops and the fibrids are formed by beating the film-like resin. The fiber chops can be intertwined with each other by thermally molten adhesion or by thermally softening deformation and serve to bond to each other the para-aramid fibers, which are a main component of the non-woven fabric. The fiber pulps and fibrids themselves are capable of being intertwined with each other and serve to bond the main component fibers to each other by paper-making them together with the para-aramid fibers. The fibers can be more strongly intertwined with each other with the thermally molten adhesion or the deformation of the second binder due to thermal softening which is accomplished by applying heat thereto.

The prepreg of the invention is formed by impregnating the sheet-like base material with a thermosetting resin and drying it and the sheet-like base material is formed of the aforementioned electrically insulating non-woven fabric.

The laminate of the invention is formed by forming under heat and under pressure the prepreg layers which are formed by impregnating the sheet-like base material with a thermosetting resin and drying it and the sheet-like base material is formed of the aforementioned electrically insulating non-woven fabric.

### BEST MODE EMBODYING THE INVENTION

An example of an electrically insulating non-woven fabric of the invention will be described hereinafter.

In this example, the non-woven fabric is formed by mixing and paper-making poly-p-phenileneterephthalamide fiber chops preferably having a fiber diameter of 1.5 denier or less, poly-p-phenileneterephthalamide fiber pulps and a second binder formed of thermoplastic resin fiber chops having a softening point of 220° C. or higher. Then, a thermosetting resin binder is sprayed onto the paper-made mixture non-woven fabric to bond the fibers to each other.

The thermosetting resin binder serves to bond the fibers to each other by being adhered to the cross points of the fibers. The thermoplastic resin fiber chops as the second binder bond the fibers to each other by thermally molten adhesion or are intertwined with the fibers by being deformed due to their thermal softening. The thus thermally molten adhesion and the intertwining due to the thermal softening can be accomplished by a calender process in which the non-woven fabric is pressurized between thermal rolls.

The poly-p-phenileneterephthalamide fiber chops may desirably have a fiber length of 3 to 6 mm. As the fiber length gets shorter, the bonded points of the fibers are reduced whereby the modulus of elasticity of the non-woven fabric is lowered. On the other hand, as the fiber length gets longer, the modulus of elasticity of the non-woven fabric gets higher, but the fiber bundling and the distribution unevenness happen on paper-making whereby the density of the non-woven fabric gets uneven.

The content of the thermosetting resin binder in the non-woven fabric may be desirably 5 to 30 mass %. If the content of the thermosetting resin binder is less than 5 mass %, then the bonding of the fibers gets weaker. The 5 mass % of the thermosetting resin binder is the content taken into consideration of providing sufficient intensity to the non-woven fabric beforehand when the non-woven fabric is introduced into the calender process in which the thermal rolls are used and also the one taken into consideration of maintaining a solvent-proof intensity of the non-woven fabric and preventing the paste blurring in the process of manufacturing the prepregs. If the content of the thermosetting resin binder is more than 30 mass %, the fibers tend to be adhered to the thermal rolls in the calender process and the thermal shrinkage of the prepregs is enhanced. Thus, 30 mass % of the thermosetting resin binder is the content taken into consideration of making an easy management of the density of the non-woven fabric by preventing the adhesion of the fibers to the thermal rolls and of controlling the thermal shrinkage of the prepregs within the preferable range. Nevertheless, the thermosetting resin binder is not barred from being used exceeding 30 mass %.

The thermosetting resin binder may be an epoxy resin and have an isocyanate resin as a hardening agent. In this case, the blend mass of the epoxy resin and the isocyanate resin may be 0.5 to 5 of the isocyanate resin relative to 10 of the epoxy resin. The hardening reaction of the epoxy resin binder progresses smoothly, and a still unreacted functional group decreases. This is useful for reducing the decline in the modulus of elasticity of the prepregs due to heat.

The content of the second binder in the non-woven fabric may be preferably higher in consideration of positively bonding the fibers to each other and preventing the thermal shrinkage of the prepregs and the warp and twisting of the laminate, but may be preferably lower in consideration of the heat resistance of the laminate. Preferably, the content of the second blinder is 5 to 15 mass %.

The thermoplastic resin fiber chops having the softening temperature of 220° C. or higher used as the second binder may be chops of meta-aramid fiber (poly-m-phenyleneisophthalamide fiber), polyester fiber, 6 nylon fiber, 66 nylon fiber, polyalylethe fiber or the like, but they are not limited thereto so long as they are of thermoplastic resin fiber having the softening temperature of 220° C. or higher. The softening temperature should be the thermal decomposition temperature or less. When the meta-aramid fiber chops are selected as the second binder, the fiber diameter thereof may be desirably 23 denier or less while the fiber length thereof may be desirably 3 to 10 mm. In order to get more places where the meta-aramid fibers are thermally molten and adhered to each other or intertwined with each other due to their thermal softening, their fiber length may be preferably longer, but in order to get the better distribution of the fibers when paper-made, their fiber length may be preferably shorter. Thus, the fiber length is appropriately controlled in view of them.

Each of the fiber chops used as the second binder may be desirably un-extended. In the description, what is meant by “un-extended” includes the one having the smaller degree of un-extension as well as the one un-extended in the concept. With the fiber chops un-extended, the operation of the thermally molten adhesion or the intertwining by the thermal rolls can be more easily accomplished.

Although the form of the second binder may be fiber pulps or fibrids other than the aforementioned fiber chops, the fiber chops might be desirable because the paper-made non-woven fabric has more voids and therefore the non-woven fabric has a better resin impregnation when the laminate is produced. The selection of the fiber chop may be desirable in view of the improvement on the humidity resistance and the insulation of the laminate.

The laminate is manufactured by using the aforementioned non-woven fabric as the base material. At first, the non-woven fabric is impregnated with an epoxy resin varnish and heated and dried to produce a prepreg. Thereafter, one sheet of prepreg or two or more sheets of prepreg placed one upon another are formed under heat and under pressure. In this case, a metal foil or foils may be placed on the surface or surfaces of the prepregs to form a metal foil clad laminate.

A printed circuit board may be formed by etching the metal foil clad laminate so as to carry out a wiring operation. Otherwise, a multi-layer printed circuit board may be manufactured by using prepreg layers as the insulation layers by a building up system.

Some examples of the invention will be described together with comparisons and prior arts hereinbelow.

### EXAMPLE 1

(Production of Electrically Insulating Non-Woven Fabric)

There were distributed underwater and paper-made poly-p-phenylene-terephthalamide fiber chops and pulps commercially available as the trade name of KEVLAR from Du Pont and poly-m-phenyleneisophthalamide fiber chops commercially available as the trade name of CONEX from TEIJIN CO., LTD. These fibers have the fiber diameter of 1.5 denier and the fiber length of 3 mm. The poly-p-phenylene-terephthalamide fiber pulps were formed by beating the poly-p-phenylene-terephthalamide fiber chops so as to have the freeness of 50 csf.

The thermosetting resin binder applied to this EXAMPLE included as main ingredients an emulsion of an epoxy resin commercially available as the trade name of “V COAT A” from DAI-NIPPON INK AND CHEMICALS INC., Japan and a block isocyanate resin commercially available under the trade name of “CR-60B” from the same company. The blend mass (hardening agent mass) of the block isocyanate resin was 1 relative to 10 mass of the epoxy resin. The thermosetting resin binder was sprayed onto the aforementioned fibers after paper-made and heated and dried to produce the non-woven fabric. Thereafter, the non-woven fabric was heated and compressed while passing between a pair of heating rolls set at the temperature of 333° C. under a line pressure of 200 kN/m.

This non-woven fabric had a unit mass of 72 g/m², the blend mass ratio of poly-p-phenylene-terephthalamide fiber chop relative to poly-p-phenylene-terephthalamide fiber pulp was 80/20, the content of the thermosetting resin binder in the non-woven fabric was 17 mass % and the content of the second binder in the non-woven fabric was 9 mass % (see Table 1(1)).

(Production of Prepregs)

Prepergs having a resin content of 52 mass % were produced by impregnating the aforementioned non-woven fabric with brominated bisphenol A-type epoxy resin varnish and heating and drying them.

(Production of a Laminate)

The four aforementioned prepregs were superposed one upon another and upper and lower copper foils having a thickness of 18 mm placed thereon. They were formed under a temperature of 170° C. and under a pressure of 4 MPa to obtain the copper clad laminate.

### EXAMPLES 2 THROUGH 25 AND COMPARISON 1

There were produced non-woven fabrics in the same manner as those of Example 1 except that the ratio of poly-p-phenylene-terephthalamide fiber chop/poly-p-phenylene-terephthalamide fiber pulp, the fiber length of poly-p-phenylene-terephthalamide fiber chop, the freeness of poly-p-phenylene-terephthalamide fiber pulp, the content of the thermosetting resin binder in the non-woven fabric, the content of the second binder in the non-woven fabric and the hardening agent mass of the thermosetting resin binder were determined as indicated in EXAMPLES 2 through 25 of Tables 1(1) through 1(6), respectively and prepregs and copper clad laminates were produced in the same manner as those of Example 1

TABLE 1 (1)

| EXAMPLE | 1 | 2 | 3 | 4 | 5 |
|---|---|---|---|---|---|
| CHOP/PULP | 80/20 | 0/100 | 45/55 | 50/50 | 90/10 |
| FIBER LENGTH | 3 | 3 | 3 | 3 | 3 |
| FREENESS (csf) | 50 | 50 | 50 | 50 | 50 |
| THERMOSETTING RESIN | 17 | 17 | 17 | 17 | 17 |
| BINDER (mass %) | | | | | |
| SECOND BINDER | 9 | 9 | 9 | 9 | 9 |
| (mass %) | | | | | |
| HARDENING AGENT MASS | 1 | 1 | 1 | 1 | 1 |

TABLE 1 (2)

| EXAMPLE | 6 | 7 | 8 | 9 | 10 |
|---|---|---|---|---|---|
| CHOP/PULP | 95/05 | 80/20 | 80/20 | 80/20 | 80/20 |
| FIBER LENGTH | 3 | 2 | 4 | 5 | 6 |
| FREENESS (csf) | 50 | 50 | 50 | 50 | 50 |
| THERMOSETTING RESIN | 17 | 17 | 17 | 17 | 17 |
| BINDER (mass %) | | | | | |
| SECOND BINDER | 9 | 9 | 9 | 9 | 9 |
| (mass %) | | | | | |
| HARDENING AGENT MASS | 1 | 1 | 1 | 1 | 1 |

TABLE 1 (3)

| EXAMPLE | 11 | 12 | 13 | 14 | 15 |
|---|---|---|---|---|---|
| CHOP/PULP | 80/20 | 80/20 | 80/20 | 80/20 | 80/20 |
| FIBER LENGTH | 7 | 3 | 3 | 3 | 3 |
| FREENESS (csf) | 50 | 600 | 550 | 50 | 50 |
| THERMOSETTING RESIN | 17 | 17 | 17 | 17 | 17 |
| BINDER (mass %) | | | | | |
| SECOND BINDER | 9 | 9 | 9 | 4 | 5 |
| (mass %) | | | | | |
| HARDENING AGENT MASS | 1 | 1 | 1 | 1 | 1 |

TABLE 1 (4)

| EXAMPLE | 16 | 17 | 18 | 19 | 20 |
|---|---|---|---|---|---|
| CHOP/PULP | 80/20 | 80/20 | 80/20 | 80/20 | 80/20 |
| FIBER LENGTH | 3 | 3 | 3 | 3 | 3 |
| FREENESS (csf) | 50 | 50 | 50 | 50 | 50 |
| THERMOSETTING RESIN | 17 | 17 | 4 | 5 | 30 |
| BINDER (mass %) | | | | | |
| SECOND BINDER | 15 | 16 | 9 | 9 | 9 |
| (mass %) | | | | | |
| HARDENING AGENT MASS | 1 | 1 | 1 | 1 | 1 |

TABLE 1 (5)

| EXAMPLE | 21 | 22 | 23 | 24 | 25 |
|---|---|---|---|---|---|
| CHOP/PULP | 80/20 | 80/20 | 80/20 | 80/20 | 80/20 |
| FIBER LENGTH | 3 | 3 | 3 | 3 | 3 |
| FREENESS (csf) | 50 | 50 | 50 | 50 | 50 |
| THERMOSETTING RESIN | 40 | 17 | 17 | 17 | 17 |
| BINDER (mass %) | | | | | |
| SECOND BINDER | 9 | 9 | 9 | 9 | 9 |
| (mass %) | | | | | |
| HARDENING AGENT MASS | 1 | 6 | 5 | 0.5 | 0.4 |

TABLE 1 (6)

| | COMPARISON 1 |
|---|---|
| CHOP/PULP | 97/03 |
| FIBER LENGTH | 3 |
| FREENESS (csf) | 50 |
| THERMOSETTING RESIN | 17 |
| BINDER (mass %) | |
| SECOND BINDER | 9 |
| (mass %) | |
| HARDENING AGENT MASS | 1 |

(Prior Art 1)

Non-woven fabrics, prepregs and copper clad laminates were produced in the same manner as those of EXAMPLE 1 except that there were used chops commercially available as the trade name of TECHNOLA from TEIJIN CO., LTD., Japan as poly-p-phenylene-3,4′-diphenylether-terephthalamide fibers, chops commercially available as the trade name of CONEX from TEIJIN CO., LTD., Japan as poly-m-phenyleneisophthalamide fibers and only the same thermosetting resin binder as used in EXAMPLE 1 as the binder. This non-woven fabric had a unit mass of 72 g/m² and had the ingredient composition of 77 mass % of poly-p-phenylene-3,4′-diphenylether-terephthalamide fiber chops, 15 mass % of poly-m-phenyleneisophthalamide fiber chops and 8 mass % of the thermosetting resin binder. The poly-m-phenyleneisophthalamide fiber chops are thermally molten and adhered to the poly-p-phenylene-3,4′-diphenylether-terephthalamide fiber chops.

(Prior Art 2)

Non-woven fabrics, prepregs and copper clad laminates were produced in the same manner as those of EXAMPLE 1 except that there were used poly-p-phenyleneterephthalamide fiber chops commercially available as the trade name KEVLAR from TEIJIN CO., LTD., Japan and only the same thermosetting resin binder as used in EXAMPLE 1 as the binder. This non-woven fabric had a unit mass of 72 g/m² and had the ingredient composition of 80 mass % of poly-p-phenylene-terephthalamide fiber chops and 20 mass % of the thermosetting resin binder. The thermosetting resin binder bonded the poly-p-phenyleneterephthalamide fiber chops to each other.

The result in which the characteristics of the prepregs and the copper clad laminates of EXAMPLES 1 through 25, COMPARISON 1 and PRIOR ARTS 1 and 2 are evaluated are shown in TABLE 2 (1) through 2(6), respectively. The evaluation items and the evaluation method are as follows.

(1) Paste Blurring

The prepregs on both sides were covered with PET films and applied heat from both PET films so as to be laminated and then had a hole formed therein by radiating laser light on the condition of a pulse width of 0.03 ms, a pulse period of 3 ms, a pulse number of 3 and an aperture diameter of 0.2 mm. (The hole making operation was carried out in the state where the prepregs are floated in the air without being placed on a support base.) After the thus formed hole was filled with copper paste, the PET films were removed from the prepregs. Then, after the prepregs were formed under a temperature of 170° C. and under a pressure of 4 MPa, the cross section of the thus obtained hole wall was observed. Little blurring of the paste shows that the roughness of the hole wall is small and therefore that the hole wall is neatly finished.

(2) Size Variation Rate

After radiating laser light onto the prepregs and making two standard holes at a predetermined interval in the prepregs, a distance between the two holes was measured. Then, the prepregs on their both faces were covered with PET films and then heat was applied thereto to laminate them. After that a distance between the holes was measured. There was calculated the size variation rate of the distance between the holes before and after the lamination.

(3) Warp of the Laminates

The copper clad laminates having the thickness of 0.1 mm and the size of 330 mm×500 mm were supplied to the etching process where there were prepared the printed circuit boards having the remaining copper area ratio of 30 % and 80n % on the front and back faces thereof, respectively. After heat of 120° C. was applied to the thus produced printed circuit boards for 35 minutes and then they are cooled, the warp of them was measured.

(4) Solder Heat Resistance

A test piece having the copper foil attached and the size of 25 mm×25 mm floated on a soldering bath of 300° C. A time was measured until air bubbles were generated in the surface layer of the test piece and then the surface swelled.

(5) Strength of the Non-Woven Fabrics

After the non-woven fabrics having the size of 250 mm×15 mm were immersed in acetone for 5 minutes, the tensile strength thereof was measured.

(6) Modulus of Elasticity of the Prepregs

The modulus of tensile elasticity of the prepregs having the size of 250 mm×15 mm was measured.

(7) Fiber Bundling

Disappearance of fiber bundling in the non-woven fabrics is indicated by ◯ while appearance of fiber bundling in the non-woven fabrics is indicated by X.

TABLE 2(1)

| EXAMPLE | | 1 | 2 | 3 | 4 | 5 |
|---|---|---|---|---|---|---|
| PASTE BLURRING (μm) | | 6 | 4 | 5 | 6 | 10 |
| SIZE VARIATION | LENGTH | −0.041 | −0.05 | −0.043 | −0.045 | −0.045 |
| RATE OF PREPREG | WIDTH | −0.040 | −0.05 | −0.042 | −0.042 | −0.041 |

| | | | | | |
|---|---|---|---|---|---|
| WARP OF LAMINATE (mm) | 5.7 | 5.0 | 5.3 | 5.5 | 5.6 |
| SOLDER HEAT RESISTANCE | 20 | 10 | 12 | 17 | 18 |
| (minutes) | | | | | |
| NON-WOVEN FABRIC | 60.0 | 64.3 | 61.2 | 60.3 | 48.3 |
| STRENGTH (N/15 mm) | | | | | |
| MODULUS OF ELASTICTY | 3.1 | 3.3 | 3.2 | 3.2 | 2.7 |
| OF PREPREG (Gpa) | | | | | |
| FIBER BUNDLING | ∘ | ∘ | ∘ | ∘ | ∘ |

TABLE 2(2)

| EXAMPLE | | 6 | 7 | 8 | 9 | 10 |
|---|---|---|---|---|---|---|
| PASTE BLURRING (μm) | | 16 | 5 | 6 | 6 | 7 |
| SIZE VARIATION | LENGTH | −0.059 | −0.045 | −0.040 | −0.041 | −0.041 |
| RATE OF PREPREG | WIDTH | −0.061 | −0.042 | −0.039 | −0.039 | −0.040 |

| | | | | | |
|---|---|---|---|---|---|
| WARP OF LAMINATE (mm) | 6.2 | 6.0 | 5.2 | 5.2 | 5.1 |
| SOLDER HEAT RESISTANCE | 18 | 20 | 20 | 20 | 20 |
| (minutes) | | | | | |
| NON-WOVEN FABRIC | 37.8 | 30.0 | 62.0 | 64.0 | 66.0 |
| STRENGTH (N/15 mm) | | | | | |
| MODULUS OF ELASTICTY | 2.4 | 1.5 | 3.3 | 3.6 | 3.8 |
| OF PREPREG (Gpa) | | | | | |
| FIBER BUNDLING | ∘ | ∘ | ∘ | ∘ | ∘ |

TABLE 2(3)

| EXAMPLE | | 11 | 12 | 13 | 14 | 15 |
|---|---|---|---|---|---|---|
| PASTE BLURRING (μm) | | 7 | 11 | 9 | 7 | 7 |
| SIZE VARIATION | LENGTH | −0.043 | −0.060 | −0.054 | −0.044 | −0.046 |
| RATE OF PREPREG | WIDTH | −0.041 | −0.055 | −0.051 | −0.043 | −0.045 |

| | | | | | |
|---|---|---|---|---|---|
| WARP OF LAMINATE (mm) | 5.0 | 6.0 | 5.8 | 14.0 | 8.0 |
| SOLDER HEAT RESISTANCE | 20 | 20 | 20 | 17 | 18 |
| (minutes) | | | | | |
| NON-WOVEN FABRIC | 68.0 | 39.4 | 45.0 | 58.0 | 56.9 |
| STRENGTH (N/15 mm) | | | | | |
| MODULUS OF ELASTICTY | 3.8 | 2.7 | 2.6 | 2.8 | 2.9 |
| OF PREPREG (Gpa) | | | | | |
| FIBER BUNDLING | x | ∘ | ∘ | ∘ | ∘ |

TABLE 2(4)

| EXAMPLE | | 16 | 17 | 18 | 19 | 20 |
|---|---|---|---|---|---|---|
| PASTE BLURRING (μm) | | 6 | 6 | 15 | 10 | 5 |
| SIZE VARIATION | LENGTH | −0.046 | −0.045 | −0.044 | −0.045 | −0.047 |
| RATE OF PREPREG | WIDTH | −0.044 | −0.044 | −0.042 | −0.042 | −0.043 |

| | | | | | |
|---|---|---|---|---|---|
| WARP OF LAMINATE (mm) | 5.0 | 4.9 | 10.0 | 5.9 | 5.1 |
| SOLDER HEAT RESISTANCE | 16 | 10 | 19 | 20 | 20 |
| (minutes) | | | | | |
| NON-WOVEN FABRIC | 54.1 | 53.2 | 32.2 | 40.2 | 52.7 |
| STRENGTH (N/15 mm) | | | | | |
| MODULUS OF ELASTICTY | 2.9 | 2.9 | 2.4 | 2.7 | 3.1 |
| OF PREPREG (Gpa) | | | | | |
| FIBER BUNDLING | ∘ | ∘ | ∘ | ∘ | ∘ |

TABLE 2(5)

| EXAMPLE | | 21 | 22 | 23 | 24 | 25 |
|---|---|---|---|---|---|---|
| PASTE BLURRING (μm) | | 4 | 6 | 6 | 6 | 6 |
| SIZE VARIATION | LENGTH | −0.052 | −0.043 | −0.045 | −0.045 | −0.046 |
| RATE OF PREPREG | WIDTH | −0.050 | −0.041 | −0.041 | −0.043 | −0.041 |

| | | | | | |
|---|---|---|---|---|---|
| WARP OF LAMINATE (mm) | 5.4 | 8.0 | 5.5 | 5.5 | 5.6 |
| SOLDER HEAT RESISTANCE | 20 | 20 | 20 | 20 | 20 |
| (minutes) | | | | | |
| NON-WOVEN FABRIC | 70.8 | 49.9 | 56.3 | 40.0 | 25.0 |
| STRENGTH (N/15 mm) | | | | | |
| MODULUS OF ELASTICTY | 3.1 | 1.5 | 2.5 | 3.0 | 3.0 |
| OF PREPREG (Gpa) | | | | | |
| FIBER BUNDLING | ∘ | ∘ | ∘ | ∘ | ∘ |

TABLE 2(6)

| | | COMPARISON | PRIOR | PRIOR |
|---|---|---|---|---|
| | | 1 | ART 1 | ART 2 |
| PASTE BLURRING (μm) | | 24 | 7 | 21 |
| SIZE VARIATION | LENGTH | −0.061 | −0.085 | −0.150 |
| RATE OF PREPREG | WIDTH | −0.058 | −0.066 | −0.130 |

| | | | |
|---|---|---|---|
| WARP OF LAMINATE (mm) | 16.0 | 32.0 | 24.0 |
| SOLDER HEAT RESISTANCE | 17 | 10 | 11 |
| (minutes) | | | |
| NON-WOVEN FABRIC | 22.0 | 24.5 | 24.5 |
| STRENGTH (N/15 mm) | | | |
| MODULUS OF ELASTICTY | 1.5 | 1.3 | 1.4 |
| OF PREPREG (Gpa) | | | |
| FIBER BUNDLING | ∘ | ∘ | ∘ |

In comparison of Table 1 with Table 2, it will be noted that the manufacture conditions and particularly the desirable conditions for accomplishing the purposes of the invention are as follows;

It will be noted that especially, in consideration of the paste blurring, the warp of the laminates and the non-woven fabric strength of EXAMPLES 1 through 6 and COMPARISON 1 which had the same manufacture conditions except for the blend mass ratio of poly-p-phenylene-terephthalamide fiber chop and poly-p-phenylene-terephthalamide fiber pulp, the blend mass ratio of poly-p-phenyleneterephthalamide fiber chop and poly-p-phenylene-terephthalamide fiber pulp may be 0/100 through 95/5, but it is preferably 50/50 through 90/10. It will be also noted from EXAMPLES 1 and 7 through and 11 which had the same manufacture conditions except for the fiber length of poly-p-phenyleneterephthalamide fiber chop that the fiber length of the chop may be 2 to 7 mm, but it may be preferably 3 to 6 mm in consideration of the fiber bundling and the modulus of elasticity of the prepregs.

Similarly, it will be noted that, in consideration of the non-woven fabric strength of EXAMPLES 1, 12 and 13 which had the same manufacture conditions except for the freeness of poly-p-phenyleneterephthalamide fiber pulp, the freeness of poly-p-phenyleneterephthalamide fiber pulp may be 600 csf or less, but it may be preferably 550 csf or less.

In EAMPLES 1 and 14 through 17 having the same manufacture conditions except for the mass % of the second binder, the content of the second binder in the non-woven fabric may be 4 to 16 mass %, but it will be noted that it may be preferably 5 to 15 mass % in consideration of the warp of the laminates and the solder heat resistance in comparison of these examples.

In EXAMPLES 1 and 18 through 21 having the same manufacture conditions except for the content of the thermosetting resin binder, the content of the thermosetting resin binder in the non-woven fabric may be 4 to 40 mass %, but it will be noted that it may be preferably 5 to 30 mass % in consideration of the non-woven fabric strength and the size variation ratio of the prepregs in comparison of these examples.

In EXAMPLES 1 and 22 through 25, in the case where the thermosetting resin binder is an epoxy resin having the hardening agent of isocyanate resin, the blend mass of the epoxy resin and the isocyanate resin is 0.4 to 6 of the isocyanate resin relative to 10 of the epoxy resin, but it will be noted that it may be preferably 0.5 to 5 of the isocyanate resin relative to 10 of the epoxy resin in view of the non-woven fabric strength and the modulus of elasticity of the prepregs in comparison of these examples.

As aforementioned, when the hole making operation of the prepregs and the insulation layers having the electrically insulating non-woven fabric as base material is made by radiating laser light, the hole wall can be finished in a better manner. Also, the size variation of the prepregs due to heat and the warp of the laminates due to heat can be prevented so as to reduce them.

Utiliability in Industry

The non-woven fabric of the invention can be suitably used for the printed circuit boards for surface-mounting various electronic devices thereon, and especially for the prepregs and the laminates for the multi-layer printed circuit boards.

1. An electrically insulating non-woven fabric having a main component of para-aramid fibers bonded with each other by a binder of thermosetting resin and a second binder of one selected from fiber chops, fiber pulps and fibrids of a thermoplastic resin having a softening point of 220° C. or higher, said para-aramid fibers characterized by including poly-p-phenileneterephthalamide fiber pulps or both of poly-p-phenileneterephthalamide fiber chops and poly-p-phenileneterephthalamide fiber pulps with a blend mass ratio of said poly-p-phenileneterephthalamide fiber chop to said poly-p-phenileneterephthalamide fiber pulp being 0/100 through 95/5.

2. An electrically insulating non-woven fabric as set forth in claim 1 and characterized in that a beating degree of said poly-p-phenileneterephthalamide fiber pulp is 550 csf or less.

3. An electrically insulating non-woven fabric as set forth in claim 2 and characterized in that a blend mass ratio of said poly-p-phenileneterephthalamide fiber chop to said poly-p-phenileneterephthalamide fiber pulp being 50/50 through 90/10.

4. An electrically insulating non-woven fabric as set forth in claim 3 and characterized in that a fiber length of said poly-p-phenileneterephthalamide fiber chops is 3 to 6 mm.

5. An electrically insulating non-woven fabric as set forth in claim 1 and characterized in that a content of said thermosetting resin binder in said non-woven fabric is 5 to 30 mass %.

6. An electrically insulating non-woven fabric as set forth in claim 5 and characterized in that said thermosetting resin binder is of an epoxy resin and has an isocyanate resin as a hardening agent with a blend mass of said epoxy resin and said isocyanate resin being 0.5 to 5 of said isocyanate resin relative to 10 of said epoxy resin.

7. An electrically insulating non-woven fabric as set forth in claim 5 and characterized in that a content of said second binder in said non-woven fabric is 5 to 15 mass %.

8. An electrically insulating non-woven fabric as set forth in claim 6 and characterized in that a content of said second binder in said non-woven fabric is 5 to 15 mass %.

9. A prepreg comprising a sheet-like base material impregnated with a thermosetting resin and dried and said sheet-like base material characterized by being of an electrically insulating non-woven fabric as set forth in either of claims 1 through 8.

10. A laminate comprising a layer or layers of prepreg formed under heat and under pressure, said prepreg being formed of a sheet-like material impregnated with a thermosetting resin and dried and said sheet-like base material being of an electrically insulating non-woven fabric as set forth in either of claims 1 through 8.
